(19) United States
(12) Patent Application Publication
(10) Pub. No.: US 2009/0172916 A1
(43) Pub. Date: Jul. 9, 2009

(54) Hinge Assembly

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/969,328

(22) Filed: Jan. 4, 2008

(51) Int. Cl. E05D 11/08

(52) U.S. Cl. 16/342

(57) ABSTRACT

A hinge assembly comprises a pintle (10) including a first section (11) for pivotally connecting to a first coupling member (20) and a second section (12) for pivotally connecting to a second coupling member (30), two second positioning-limiting members (40) and a first friction device (50). The second coupling member includes a projection (312) and a protuberance (333) formed thereon. The first coupling member, the pintle and the second position-limiting members are adapted to be rotated simultaneously relative to the second coupling member, and one second positioning-limiting member can be rotated to contact the projection while the other be rotated to contact the protuberance for stopping a further increase in an angle of first coupling member relative to the second coupling member, and the first friction device are adapted to provide for force to hold the first coupling member at an angular relation relative to the second coupling member.

### BACKGROUND OF THE INVENTION

1. Field of the Invention

The present invention relates to a hinge assembly, in particular to a hinge assembly that can be used under high loading condition.

2. Description of the Related Art

Referring to U.S PUB. APP. No. 2004/0025298, a hinge that can be used with a notebook computer or the like includes an assembly board 30 having a guide plate 31 and a locking portion 33 defined thereon, and a baffle 42 having a projective portion 46 locked onto the locking portion 33 of the guide plate 31 to limit the rotation angle of the assembly board 30 on the small-diameter rod 12. Unfortunately, if the notebook has a heavy display or if the display is equipped with other accessories, such as a web cam, a mini loudspeaker, an antenna, and others, the baffle 42 is liable to distortion due to not sturdy enough to support these weights and further loses its original tightness to maintain the desired resistance consequently.

The present invention is, therefore, intended to obviate or at least alleviate the problems encountered in the prior art.

### SUMMARY OF THE INVENTION

It is therefore an object of the present invention to provide a hinge assembly that prevents distortion of its components under relatively high loading condition.

Accordingly, a hinge assembly comprises a pintle including a first section for pivotally connecting to a first coupling member and a second section for pivotally connecting to a second coupling member, two second positioning-limiting members and a first friction device. The second coupling member includes a projection and a protuberance formed thereon. The first coupling member, the pintle and the second position-limiting members are adapted to be rotated simultaneously relative to the second coupling member, and one second positioning-limiting member can be rotated to contact the projection while the other be rotated to contact the protuberance for stopping a further increase in an angle of first coupling member relative to the second coupling member, and the first friction device are adapted to provide for force to hold the first coupling member at an angular relation relative to the second coupling member.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with a first embodiment of the present invention.

FIG. 2 is an exploded perspective view of the hinge assembly of FIG. 1.

FIG. 3 is a front elevation view of the hinge assembly of FIG. 1.

FIG. 4 is a cross-sectional view taken along line 4-4 of FIG. 1.

FIG. 5 is similar to FIG. 4, but illustrates the hinge assembly with a first coupling member being rotated to another position.

FIG. 6 is a perspective view of a hinge assembly in accordance with a second embodiment of the present invention.

FIG. 7 is an exploded perspective view of the hinge assembly of FIG. 6.

FIG. 8 is an exploded perspective view of the hinge assembly of FIG. 6 taken from a different angle of view.

FIG. 9 is a front elevation view of the hinge assembly of FIG. 6.

FIG. 10 is a cross-sectional view taken along line 10-10 of FIG. 6.

FIG. 11 is similar to FIG. 10, but illustrates the hinge assembly with a first coupling member being rotated to another position.

### DETAILED DESCRIPTION OF THE PREFERRED EMBODIMENT

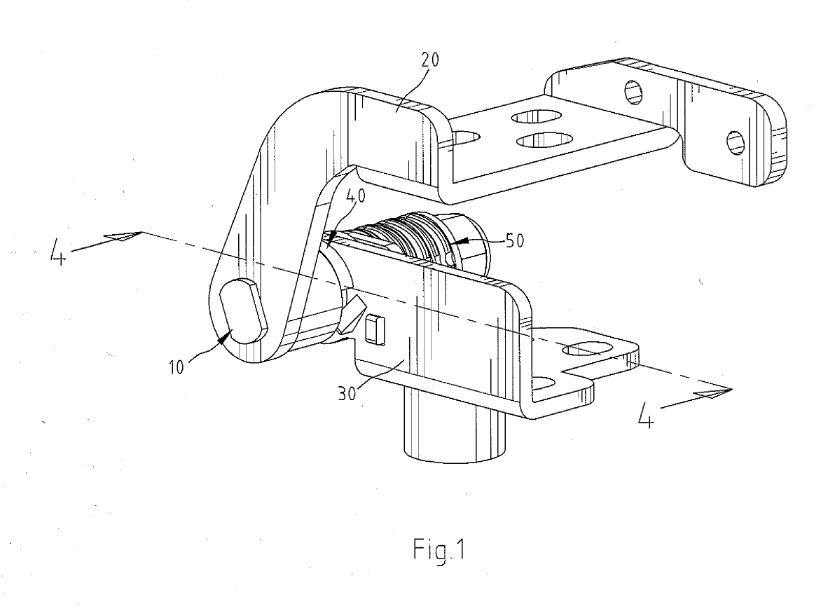

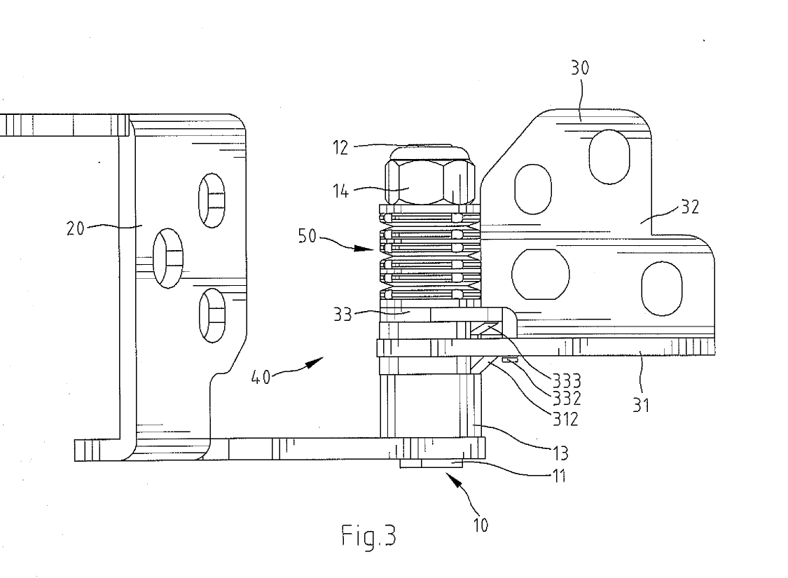

Referring to FIGS. 1 through 3, a hinge assembly that can be used to support a relatively heavy hinged member includes a pintle 10 having a first and a second section 11, 12 and a shoulder 13 formed therebetween. A first coupling member 20, which pivots in concert with the pintle 10 and is adapted to connect to a cover of a notebook computer or the like, includes a hole 21 receiving the first section 11. Furthermore, a second coupling member 30, two second position-limiting members 40, and a first friction device 50 are pivotally mounted on the second section 12, which includes an end portion 121 having threaded sides for threadly engaging with an end cap 14. Thus, the aforementioned elements 30, 40, 50 are retained between the shoulder 13 and the end cap 14 on the second portion 12.

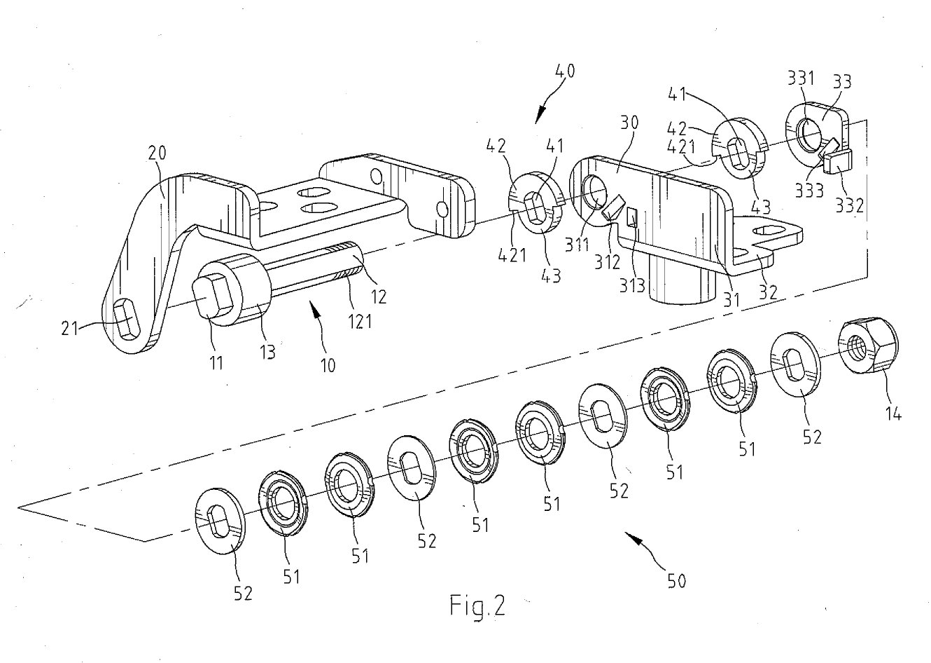

The second coupling member 30, which is adapted to connect to a base of the notebook or the like, includes a side 31 and a base 32 extended in an angled relation. Preferably, the base 32 extends orthogonally to the side 31. The side 31 includes an orifice 311 through which inserted the second section 12 of the pintle 10. The orifice 311 permits the first and second coupling members 20, 30 pivot with respect to each other. The side 31 further has a surface having a projection 312 monolithically formed thereon and a first aperture 313. The second coupling member 30 further includes a first position-limiting member 33, which may be separately formed, as seen in FIG. 2. However, the second coupling member 30 and the first position-limiting member 33 may be integrally formed as one piece.

The first position-limiting member 33 includes an engagement hole 331 through which inserted the second section 12 of the pintle 10, a hook portion 332 engaged in the first aperture 313 so as to rotate in concert with the side 31, and a surface having a protuberance 333 monolithically formed thereon.

Each second position-limiting member 40 includes a hole 41 through which inserted the second section 12 of the pintle 10. One of the second position-limiting members 40 is disposed against the surface of the side 31 of the second coupling member 30 where the projection 312 extends. Another second position-limiting member 40 is disposed against the surface of the first position-limiting member 33 where the protuberance 333 extends. Each second position-limiting member 40 further includes a first and a second arcuate peripheral edge 42, 43, and an engagement surface 421 interconnecting the first and second peripheral edges 42, 43. The engagement surface 421 extends radially inwards from the first peripheral edge 42 to join the second peripheral edge 43.

The first friction device 50 provides for force to hold the first coupling member 20 at an angular position relative to the second coupling member 30 and is positioned between the first position-limiting member 33 and the end cap 14. The first friction device 50 includes a plurality of disk-shaped resilient rings 51 and spacers 52 disposed in tandem on the second section 12 of the pintle 10. Every two resilient rings 51 are disposed between two spacers 52, the spacers 52 are provided for reducing friction wear to the resilient rings 51. In addition, the resilient rings 51 are oppositely oriented.

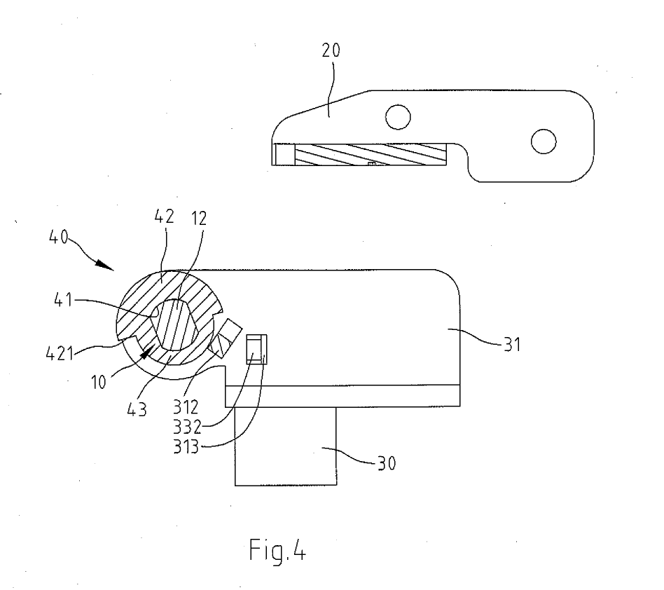

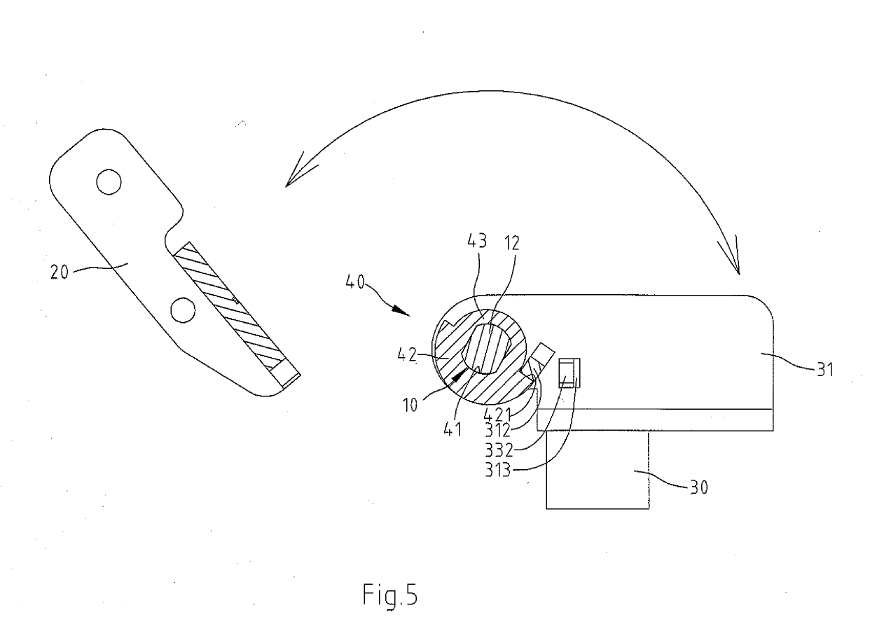

Referring to FIGS. 4 and 5, the first coupling member 20, the pintle 10 and the second position-limiting members 40 are adapted to be rotated simultaneously relative to the second coupling member 30 and be stopped until the engagement surface 421 of one second position-limiting member 40 abuts against the projection 312 and the engagement surface 421 of another second position-limiting member 40 abuts against the protuberance 333 of the first position-limiting member 33. As such, the first coupling member 20 of the embodiment can be prevented from further increase in an angle relative to the second coupling member 30. Further, the contacting of engagement surface 421 of one second position-limiting member 40 with the projection 312 and the engagement surface 421 of another second position-limiting member 40 with the protuberance 333 enables the first and second coupling members 20, 30, which may connect to relatively heavy structures, to be steadily supported at this hinged condition, without causing damage to the hinge assembly.

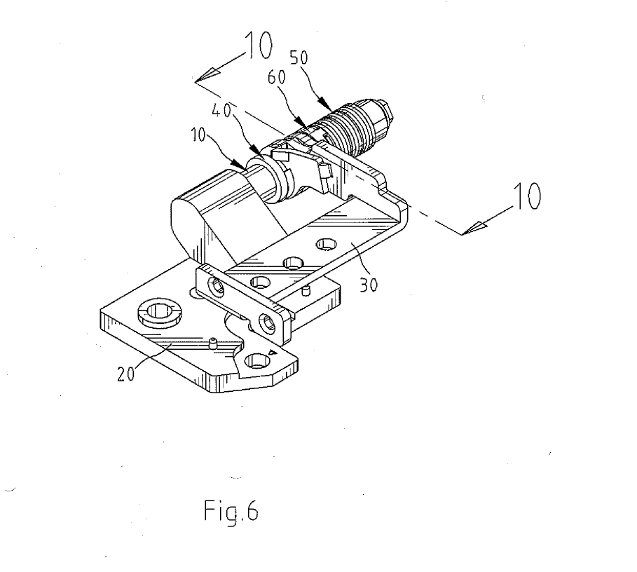

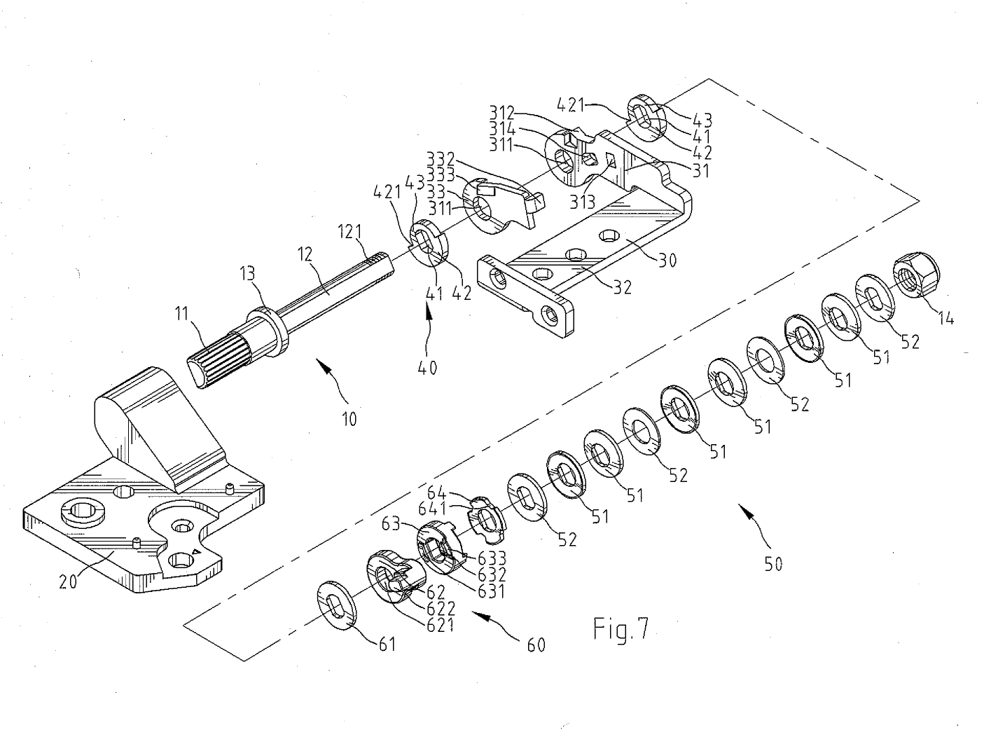

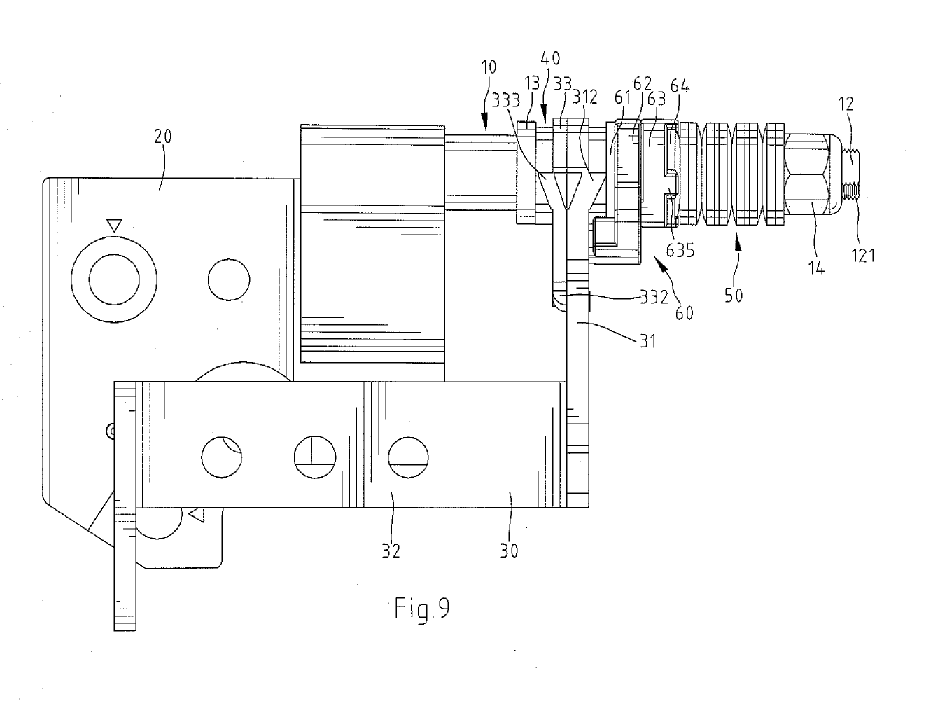

FIGS. 6 through 9 show a second embodiment of the hinge assembly in accordance with the present invention. The hinge assembly is similar to the prior embodiment except that a second friction device 60 is disposed in tandem with the first friction device 50 on the second section 12 of the pintle 10. The first/second friction devices 50, 60 combination is used for holding the first coupling member 20 at an angular position relative to the second coupling member 30. As seen in FIG. 7, the second friction device 60 includes a washer 61, a positioning member 62, a rotating member 63 and a resilient member 64. In addition, the side 31 of the second coupling member 30 further includes a second aperture 314. The positioning member 62 has a stub 622 engaged in the second aperture 314 so as to rotate in concert with the side 31.

Like the prior embodiment, the second coupling member 30 and the first position-limiting member 33 may be separately formed, as seen in FIG. 7 or may be integrally formed as one piece.

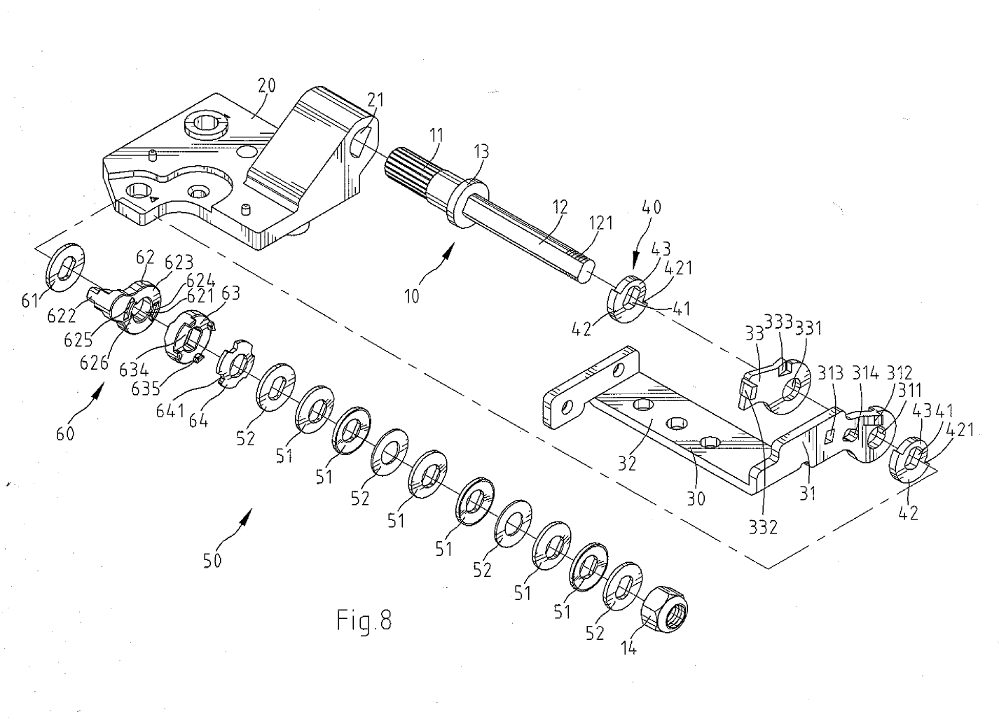

As also seen in FIGS. 7 and 8, the position member 62 has an orifice 621 through which inserted the second section 12 of the pintle 10, a surface 623 on which formed a first, a second and a third fanwise indentation 624, 625 and 626, which are disposed at a different radial distance with respect to the center thereof. The rotating member 63 includes a first surface having a first, second and third fanwise detent 631, 632, and 633 formed thereon and is adapted to be rotated relative to the position member 62. Moreover, the fanwise detents 631, 632, and 633 can be rotated to complemently engage in and out of the associated fanwise indentations 624, 625 and 626 correspondingly upon different angular positions of first coupling member 20 with respect to the second coupling member 30. The rotating member 63 further includes a second surface 634 from which extended four equally distributed protrusions 635 that are receivable in four recessed edges 641 defined by the resilient member 64 correspondingly.

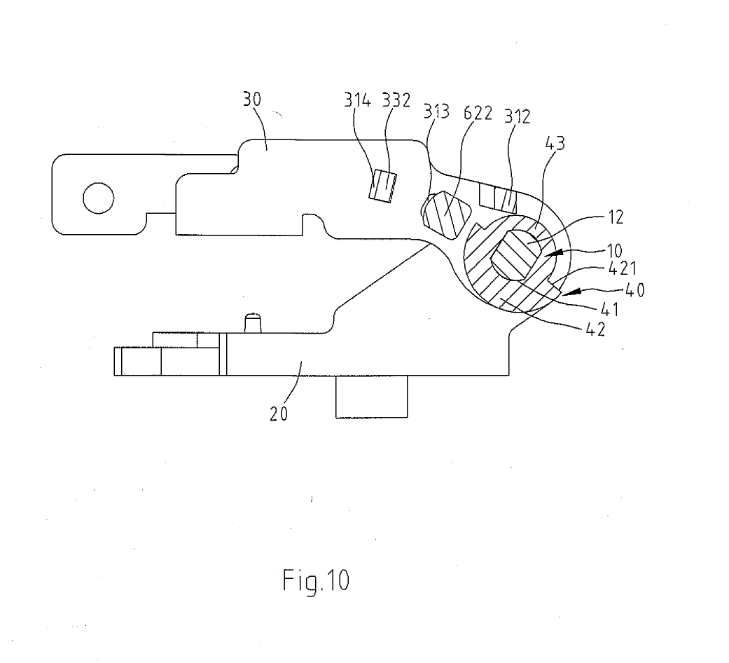

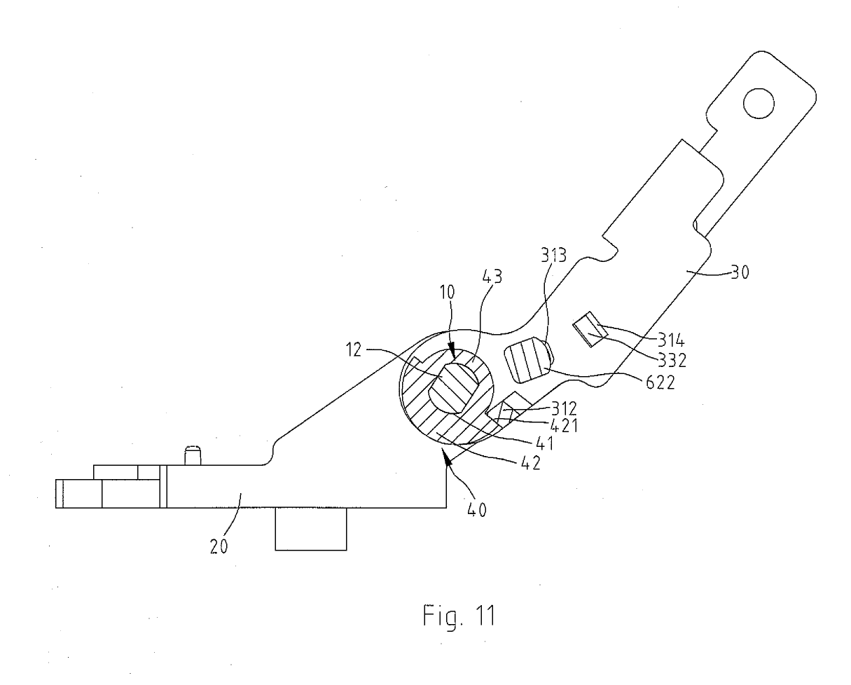

Referring to FIGS. 10 and 11, the first coupling member 20, the pintle 10 and the second position-limiting members 40 are adapted to be rotated simultaneously relative to the second coupling member 30 and be stopped until the engagement surface 421 of one second position-limiting member 40 abuts against the projection 312 and the engagement surface 421 of another second position-limiting member 40 abuts against the protuberance 333 of the first position-limiting member 33. As such, the second coupling member 30 of this embodiment can be prevented from further increase in an angle relative to the first coupling member 20. Further, the contacting of engagement surface 421 of one second position-limiting member 40 with the projection 312 and the engagement surface 421 of another second position-limiting member 40 with the protuberance 333 enables the first and second coupling members 20, 30, which may connect to relatively heavy structures, to be steadily supported at this hinged condition, without causing damage to the hinge assembly.

While the specific embodiments have been illustrated and described, numerous modifications come to mind without significantly departing from the spirit of invention and the scope of invention is only limited by the scope of accompanying claims.

What is claimed is:

1. A hinge assembly that can be used to support relatively heavier hinged member comprising:
a pintle including a first section and a second section;
a first coupling member pivotally connected to the first section of the pintle;
a second coupling member, pivotally connected to the second section of the pintle and including a projection and a protuberance formed thereon;
two second positioning-limiting members pivotally connected to the second section of the pintle; and
a first friction device pivotally connected to the second section of the pintle; and
wherein the first coupling member, the pintle and the second position-limiting members are adapted to be rotated simultaneously relative to the second coupling member; and
wherein one second positioning-limiting member can be rotated to contact the projection while the other be rotated to contact the protuberance for stopping a further increase in an angle of first coupling member relative to the second coupling member; and
wherein the first friction device are adapted to provide for force to hold the first coupling member at an angular relation relative to the second coupling member.

2. The hinge assembly as claimed in claim 1 wherein the second coupling member comprises a first position-limiting member, and wherein the protuberance is formed on the first position-limiting member.

3. The hinge assembly as claimed in claim 2 wherein the first position-limiting member comprises a hook portion, and wherein the second coupling member comprises a first aperture, and the hook portion is adapted to engage in the first aperture.

4. The hinge assembly as claimed in claim 1 wherein the first friction device comprises a plurality of resilient rings and spacers disposed in tandem on the second section of the pintle.

5. The hinge assembly as claimed in claim 4 wherein every two resilient rings are disposed between two spacers, the spacers are provided for reducing friction wear to the resilient rings upon the rotation of the first coupling member relative to the second coupling member.

6. The hinge assembly as claimed in claim 1 further comprising a second friction device pivotally connected to the second section of the pintle and disposed in tandem with the first friction device.

7. The hinge assembly as claimed in claim 6 wherein the second friction device comprises a positioning member and a rotating member, the positioning member includes a first, a second and a third fanwise indentation, the rotating member includes a first, a second and a third detent and is adapted to be rotated relative to the position member and rotated to complemently engage in and out the associated indentations.

8. The hinge assembly as claimed in claim 6 wherein the second coupling member comprises a first position-limiting member, and wherein the protuberance is formed on the first position-limiting member.

9. The hinge assembly as claimed in claim 7 wherein the first position-limiting member comprises a hook portion, and wherein the second coupling member comprises a first aperture, and the hook portion is adapted to engage in the first aperture.

10. The hinge assembly as claimed in claim 1 wherein the first friction device comprises a plurality of resilient rings and spacers disposed in tandem on the second section of the pintle.

11. The hinge assembly as claimed in claim 10 wherein every two resilient rings are disposed between two spacers, the spacers are provided for reducing friction wear to the resilient rings upon the rotation of the first coupling member relative to the second coupling member.
